(19) United States
(12) Patent Application Publication
(10) Pub. No.: US 2009/0259819 A1
(43) Pub. Date: Oct. 15, 2009

(54) METHOD OF WEAR LEVELING FOR NON-VOLATILE MEMORY

(75) Inventors: YEN MING CHEN, HSINCHU (TW); SHIH CHIEH TAI, HSINCHU (TW); YUNG LI JI, HSINCHU (TW); CHIH NAN YEN, HSINCHU (TW); FUJA SHONE, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: SKYMEDI CORPORATION, HSINCHU (TW)

(21) Appl. No.: 12/100,136

(22) Filed: Apr. 9, 2008

(51) Int. Cl. G06F 12/02; G06F 13/00; G06F 12/00

(52) U.S. Cl. 711/165; 711/170; 711/E12.001; 711/E12.002

(57) ABSTRACT

A method of wear leveling for a non-volatile memory is performed as follows. First, the non-volatile memory is divided into a plurality of zones including at least a first zone and a second zone. The first zone is written and/or erased in which one or more logical blocks have higher writing hit rate, and therefore the corresponding physical blocks in the first zone will be written more often. The next step is to find one or more free physical blocks in second zone. The physical blocks of the first zone are replaced by the physical blocks of the second zone if the number of write and/or erase to the first zone exceeds a threshold number. The replacement of physical blocks in the first zone by the physical blocks in the second zone may include the steps of copying data from the physical blocks in the first zone to the physical block in the second zone, and changing the pointer of logical blocks to point to the physical blocks in the second zone.

### BACKGROUND OF THE INVENTION

(A) Field of the Invention

The present invention is related to a method of wear leveling for a non-volatile memory.

(B) Description of Related Art

Wear leveling technology usually divides a non-volatile memory into a plurality of zones for recording in consideration of the limitation of RAM size, and every single zone usually contains a plurality of blocks. For wear leveling to blocks on the zone base, the blocks are worn uniformly in a zone, but normally the wear in different zones is not equal.

FIG. 1A and FIG. 1B show an example of the wear for a non-volatile memory, e.g., a flash memory, in which every zone comprises 1,024 blocks (Block 0 to Block 1023), and Logical Block 0 of Zone 0 stores the File Allocation Table (FAT), which is updated whenever data is written to any zone.

A physical block is a fixed, physical address of a block of data on a non-volatile memory. A logical block is the address that host or operating system uses it to read/write a block of data on a non-volatile memory. A logical block is point to a physical block on a non-volatile memory which the operating system can use to read/write the data of the physical block.

The File Allocation Table (FAT) is a partially patented file system developed by Microsoft for MS-DOS and was the primary file system for consumer versions of Microsoft Windows up to and including Windows Me. FAT as it applies to flexible/floppy and optical disk cartridges (FAT12 and FAT16 without long file name support) has been standardized as ECMA-107 and ISO/IEC 9293. The FAT file system is relatively uncomplicated, and is supported by virtually all existing operating systems for personal computers.

For Zone 0, i.e., Physical Block 0 to Physical Block 1023, the erase count is generally between 6,000 and 7,000. For Zone 1, i.e., Physical Block 1024 to Physical Block 2047, the erase count is around 3,300 to 3,500. For Zone 2, i.e., Physical Block 2048 to Physical Block 3071, the erase count is around 3,000 to 3,400. For Zone 3, i.e., Physical Block 3071 to Physical Block 4095, the erase count is around 3,600 to 3,800.

Because Logical Block 0 in Zone 0 usually stores the FAT, it can be seen that the erase (wear) occurs more often in Zone 0 than in other Zones. Therefore, although Zone 0 also performs wear leveling, the high wear rate caused by the FAT increases the average wear count in Zone 0 more rapidly than in other zones.

Therefore, it is useful to decrease the wear counts in the first Zone (Zone 0), so that the wear in all Zones can be equalized. As a result, the endurance of the non-volatile memory can be increased.

### SUMMARY OF THE INVENTION

The present invention provides a method of wear leveling for a non-volatile memory, by which the logical blocks of a zone having higher writing hit rates will change the pointer thereof to aim to some free physical blocks in other zones, so that the wear in all zones can be equalized and the endurance of the non-volatile memory can be increased.

According to the method of wear leveling for a non-volatile memory of the present invention, the non-volatile memory is divided into a plurality of zones including at least a first zone, e.g., Zone 0, and a second zone, e.g., Zone 1. The first zone is subjected to wear, i.e., written and/or erased, in which at least one first physical block mapped by an logical block having higher writing hit rate is written and/or erased more often and therefore resulting in higher writing and/or erasing count in the first zone. For example, the logical block having higher writing hit rate may store the file allocation table (FAT).

The next sequential step is to find a free second physical block in the second zone. The first physical block in the first zone is replaced by the second physical block in the second zone when the write and/or erase count of the first zone exceeds a threshold number. In an embodiment, the replacement of the first physical block by the second physical block may include the steps of copying the data of the first physical block in the first zone to the second physical block in the second zone, and changing the logical block originally pointing to the first physical block to point to the second physical block. As such, when writing or erasing again, the FAT in the second block will be updated.

In practice, the present application is not limited to one block replacement; plural blocks in a zone can be replaced by other blocks in the same zone or different zones for flexibility consideration.

### BRIEF DESCRIPTION OF THE DRAWINGS

FIG. 1A illustrates the relation between physical block address and erase count of a prior art;

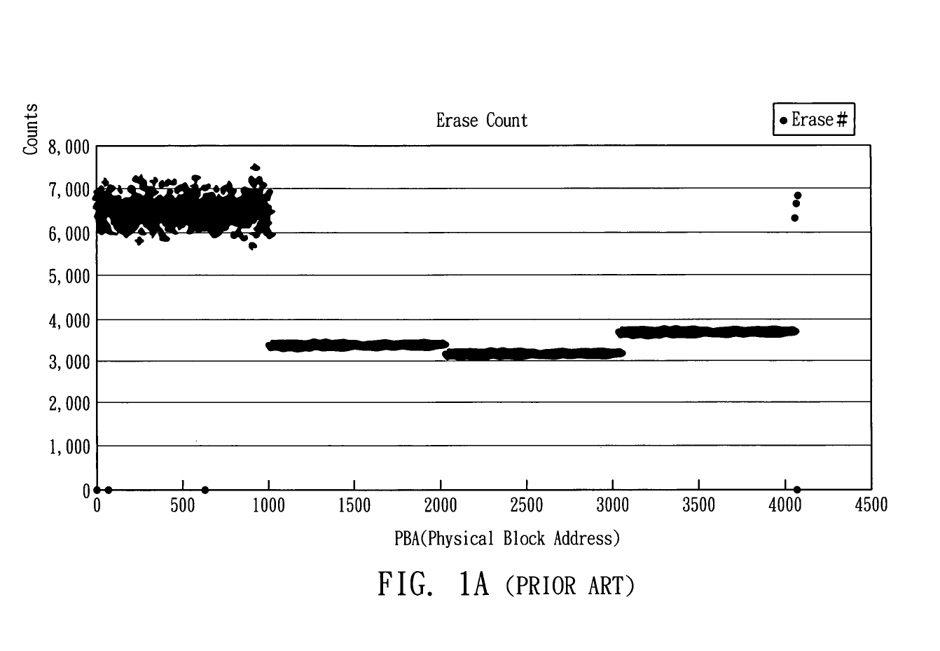

FIG. 1B illustrates the FAT location in a zone in accordance with the prior art;

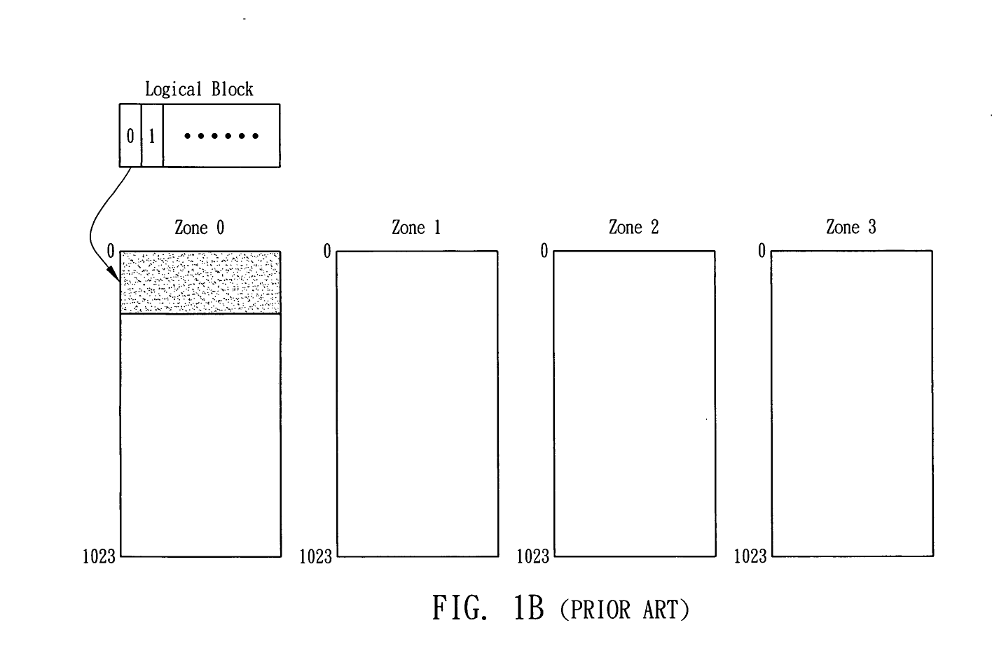

FIG. 2A illustrates an example of the relation between physical block address and erase count in accordance with the present invention;

FIG. 2B illustrates an example of block replacement of the method of wear leveling for a non-volatile memory in accordance with the present invention; and

FIG. 3 illustrates a flow chart of the method of wear leveling for a non-volatile memory in accordance with the present invention.

### DETAILED DESCRIPTION OF THE INVENTION

Embodiments of the present invention will now be described with reference to the accompanying drawings.

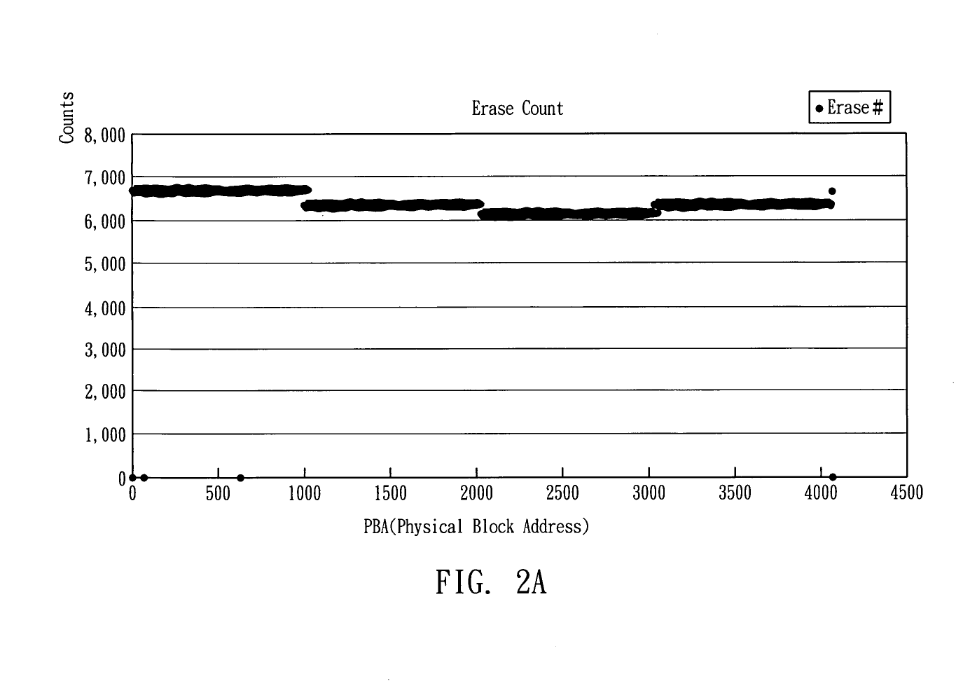

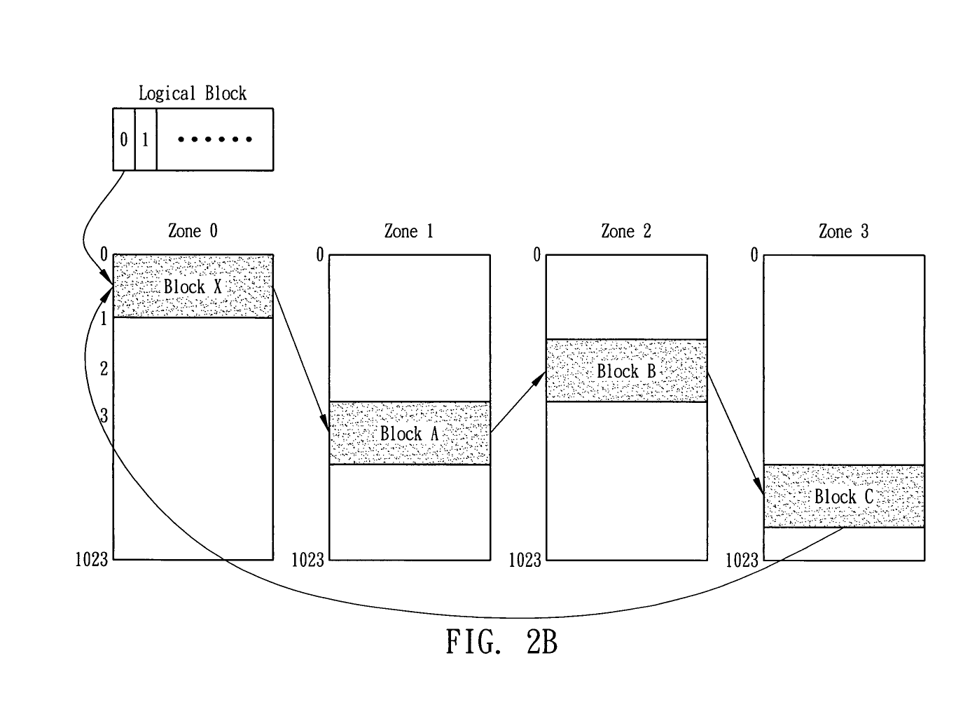

Referring to FIG. 2A and FIG. 2B, a non-volatile memory such as a flash memory is divided into four zones including Zone 0, Zone 1, Zone 2 and Zone 3. Each zone includes 1,024 physical blocks (Block 0 to Block 1023), and thus there are in total 4,096 blocks in the non-volatile memory.

If the number of write and/or erase in a zone exceeds a threshold number, wear leveling between the zones is started. While the procedural data is being built in Zone 0, e.g., table establishment between logical blocks and physical blocks, Zone 1 is scanned concurrently so as to find a free Physical Block A for later block replacement.

Because Logical Block 0 storing FAT may have higher writing hit rate, Logical Block 0 is selected but not limited to be exemplified below. If the Logical Block 0 directs to Physical Block X in Zone 0 when the number of write and/or erase in Zone 0 exceeds a threshold number, the data in Physical Block X of Zone 0 is copied to the selected Physical Block A in Zone 1. Next, the data in Block X of Zone 0 is deleted, and the Logical Block 0 originally pointing to Block X is changed to point to Block A. In other words, Block X is replaced by Block A. The pointer of the logical block address Logical Block 0 pointing to Block A is recorded for later use.

When the copy of Block X to Block A is completed, a preliminary scan on Zone 2 is started, and a free Block B is selected for later block replacement.

For accessing Logical Block 0, according to the pointer of Logical Block 0, Block A's copy of Block X in Zone 1 can be directed. In other words, for accessing Logical Block 0, the pointer will switch from Zone 0 to Zone 1. If the number of write to Zone 1 exceeds a threshold number, the data of Block A is copied to Block B in Zone 2, and the data in Block A in Zone 1 is deleted. Next, the zone pointed to by Logical Block 0 is recorded. Likewise, a similar replacement can be implemented between Block B in Zone 2 and a free Block C in Zone 3.

In the period between the block replacements, other wear leveling is still performed in each zone. That is, blocks with high wear counts are replaced with blocks having low wear counts.

The steps of finding a free block in another zone and the block replacement mentioned above can be repeated. As such, the wear count for Zone 0 can be significantly decreased, and the wear between zones can be equalized.

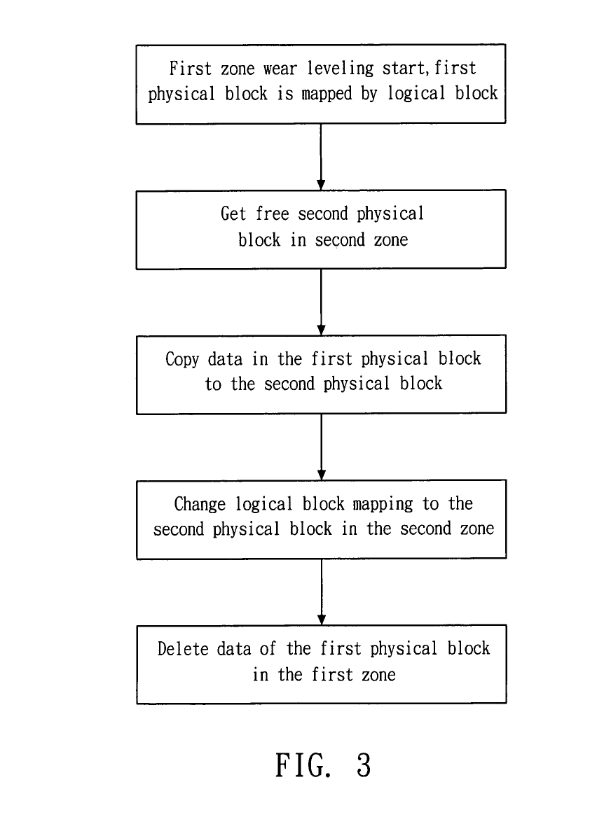

In summary, the method of wear leveling for a non-volatile memory can be illustrated in the flow chart shown in FIG. 3. When wear leveling for a first zone is started, in which a first physical block is mapped by an logical block having higher writing hit rate, a free second physical block is obtained in a second zone. Then the first physical block is replaced by the second physical block if the number of write and/or erase to the first zone exceeds a threshold number, in which the data in the first physical block is copied to the second physical block and the logical block is changed to be mapping to the second physical block. Finally, the data of the first physical block in the first zone is erased.

In practice, the present application is not limited to one block replacement; plural blocks in a zone can be replaced by other blocks in the same zone or different zones as well. For instance, three blocks in Zone 0 can be replaced by three blocks in Zone 1. Likewise, the three blocks in Zone 1 can be replaced by three blocks in Zone 2, and the three blocks in Zone 2 can be replaced by three blocks in Zone 3 afterwards.

The above-described embodiments of the present invention are intended to be illustrative only. Numerous alternative embodiments may be devised by those skilled in the art without departing from the scope of the following claims.

What is claimed is:

1. A method of wear leveling for a non-volatile memory, comprising the steps of:
providing a logical block having higher writing frequency, and the logical block pointing to a first physical block in a first zone of the non-volatile memory;
finding a second physical block that is free in a second zone of the non-volatile memory;
copying data of the first physical block in the first zone to the second physical block in the second zone; and
changing a mapping of the logical block to point to the second physical block in the second zone.

2. The method of claim 1, wherein the step of copying data from the first physical block in the first zone to the second physical block in the second zone is performed when the number of write and/or erase to the first zone exceeds a threshold number.

3. The method of claim 2, wherein data of the first physical block is erased after copying data of the first physical block in the first zone to the second physical block in the second zone.

4. The method of claim 1, wherein the step of finding a second physical block is performed when rebuilding a table mapping logical blocks to physical blocks in the first zone.

5. The method of claim 2, wherein the first or other zone can performs other wear leveling algorithm.

6. The method of claim 1, wherein the logical block comprises the File Allocation Table (FAT).

7. A method of wear leveling for a non-volatile memory, comprising the steps of:
dividing the non-volatile memory into zones including at least a first zone and a second zone;
writing or erasing the first zone in which a logical block has higher writing or erasing count, the logical block pointing to a first physical block in the first zone;
finding a second physical block that is free in the second zone; and
replacing the first physical block by the second physical block when the number of write and/or erase to the first zone exceeds a threshold number.

8. The method of claim 7, wherein the step of replacing the first physical block by the second physical block comprises:
copying data of the first physical block in the first zone to the second physical block in the second zone; and
changing a mapping of the logical block to point to the second physical block in the second zone.

9. The method of claim 8, further comprising the step of erasing data of the first block after changing the logical block to point to the second physical block in the second zone.

10. The method of claim 7, wherein the logical block comprises the File Allocation Table (FAT).

11. The method of claim 7, wherein finding a second physical block is performed when rebuilding a table mapping logical blocks to physical blocks in the first zone.

12. The method of claim 7, wherein the step of writing or erasing the first zone undergoes other wear leveling algorithm.

13. The method of claim 7, wherein the second zone is next to the first zone.
